(19) United States
(12) Patent Application Publication
(10) Pub. No.: US 2023/0399202 A1
(43) Pub. Date: Dec. 14, 2023

(54) LIFTING FRAME FOR LIFTING A TRANSFORMER OR REACTOR

(71) Applicant: HITACHI ENERGY SWITZERLAND AG, Baden (CH)

(72) Inventors: Sauro VANNICOLA, Cunardo (IT); Luigi DE MERCATO, Varese (IT); Alessio FRASCARIA, Gallarate (IT); Antonio CRESPI, Galliate Lombardo (IT)

(21) Appl. No.: 18/034,553

(22) PCT Filed: Dec. 1, 2021
(86) PCT No.: PCT/EP2021/083723

§ 371 Date: Apr. 28, 2023

(30) Foreign Application Priority Data
Dec. 2, 2020 (EP) 20211307.2

(51) Int. Cl. B66C 1/16

(52) U.S. Cl. CPC B66C 1/16

(57) ABSTRACT

A lifting frame for lifting a transformer or reactor is provided that includes a frame wall section. The frame wall section extends within a frame wall section plane. A lifting opening is formed within the frame wall section, wherein a lifting opening axis is oriented normal with respect to the frame wall section plane. The frame wall section immediately surrounding the lifting opening has a thickness that increases with decreasing distance to the lifting opening axis. This construction allows for providing an edge of the lifting opening with a comparatively large surface or contact area, while avoiding an overdesign of the frame wall section thickness. An increase in the surface of the edge generally reduces a contact pressure.

### CROSS REFERENCE TO RELATED APPLICATIONS

This application is a 35 U.S.C. § 371 national stage application of PCT International Application No. PCT/EP2021/083723 filed on Dec. 1, 2021, which in turn claims foreign priority to European Application No. 20211307.2, filed on Dec. 2, 2020, the disclosures and content of which are incorporated by reference herein in their entirety.

### BACKGROUND

The present disclosure relates to a lifting frame for lifting a transformer or reactor.

A transformer is a passive electrical device that transfers electrical energy from one electrical circuit to another, or to multiple circuits. A typical transformer comprises a ferromagnetic core having parallel limbs, extending between a bottom yoke and a top yoke. Coils or windings are wounded around the limbs. A varying current in any one of the windings produces a varying magnetic flux in the core, which induces a varying electromotive force across any other winding wound around the core.

A typical transformer may, for example, have a mass between 14·10³ kg and 18·10³ kg. Therefore, transporting a transformer, e.g., in order to replace the transformer by another one, is a challenging task, in particular with respect to safety aspects.

It is known to lift a transformer by using individually designed a lifting eye. The lifting eye can be an integral part of an upper clamping profile of the transformer or an accessory embedded through bolting or welding joints. The transformer is provided within an enclosure to guarantee a certain protection degree. It might be generally problematic to find access to the lifting eye without compromising the protection of the transformer, since a roof of the enclosure, bus bars or other accessories may obstruct the access. In such a case, lifting points are moved from the upper clamping profile of the transformer to the rooftop using commercial pad-eyes which are rigidly connected to the upper clamping profile by means of tie-rods.

Further, commercial pad-eyes may be used. However, this typically involves an oversizing of the entire lifting construction. In addition to this, due to the limitation of their capability in supporting out of plane forces, crane operators are responsible for the correct alignment of the pad-eye with lifting slings. Since this is a manual operation, any improper usage of the pad-eye can potentially lead to a safety criticality.

More specifically, commercial pad-eyes are designed to withstand a quite high safety factor due to the fact that they fall within the lifting appliances category. The relevant tie-rod is therefore selected to fit the commercial lifting eye. This typically results in a significant over-design of the tie-rod itself and the relevant lifting chain. Moreover, the dimensions of lifting eyes are standardized to reduce manufacturing costs. Accordingly, dimensions of available eyes might not be compatible with dimensions ultilized under certain circumstances.

Moreover, when a set of four chains connected to a master link is used, carrying forces are not vertically aligned. In this case, significant horizontal force components are present. In order to avoid failure of the tie-rods and/or lifting eyes induced by bending moments due to the horizontal force components, an additional frame structure under the rooftop is necessary. Further, a commercial lifting eye shall be used aligned with the direction of a corresponding lifting sling. This implies that the adjustment of a proper inclination of the lifting eye must be carried out manually. This is generally critical. For example, this task may be up to a crane operator who is not adequately trained to perform the lifting eye adjustment.

Similar problems arise regarding transportation of reactors.

Therefore, there is a need for an improved lifting frame for lifting a transformer or reactor as well as a transformer and reactor comprising an improved lifting frame. The transformer may have the additional features as describer hereinabove.

This object is achieved by the independent claim. Dependent claims refer to additional embodiments. Additional and/or alternative aspects of the present disclosure are discussed in the specification and in the aspects.

### SUMMARY

According to the present disclosure a lifting frame for lifting a transformer or reactor is provided that comprises a frame wall section. The frame wall section extends within a frame wall section plane. A lifting opening is formed within the frame wall section, wherein a lifting opening axis is oriented normal with respect to the frame wall section plane. The opening may define an opening plane. The opening plane may lay within the plane of the frame wall section and the lifting opening axis may extend perpendicular to the lifting opening plane. The frame wall section immediately surrounding and/or defining the lifting opening has a thickness that increases with decreasing distance to the lifting opening axis. The frame wall section may be thickest where the frame wall section defining the opening ends and the opening begins.

This construction allows for providing an edge, i.e., the thickened frame wall section, of the lifting opening with a comparatively large surface or contact area, while avoiding an overall oversizing of the frame wall section thickness. An increase in the surface of the edge generally allows for a reduction of a contact pressure that might be for example induced by a hook or similar part of a lifting mechanism inserted through the lifting opening. Accordingly, an oversizing or overdesign of the lifting frame can be avoided. In this way, the thickness of the frame wall section is just locally increased. This allows a stable construction which, at the same time, maintains stability and strength and saves weight and costs. In addition to this, the construction allows for a significant reduction in local stresses. Besides, no protective coating is required that would accrue scraps. The diameter of the opening and its length measured along the lifting opening axis may be chosen to fit with a hoist or shackle type that shall be used to lift the transformer or reactor mass.

Herein, an “opening axis” is generally used to describe an axis extending through the corresponding opening, wherein the axis is oriented perpendicular with respect to a plane defined be the edge of the opening, i.e. with respect to a plane that is defined by a wall section immediately surrounding the opening and forming the edge of the opening.

While the frame wall section immediately surrounding and/or defining the lifting opening is described herein as having a thickness that increases with decreasing distance to the lifting opening axis, said thickness may alternatively be described as decreasing with increasing distance from the lifting opening axis.

The frame wall section may be thickest where the frame wall section defining the opening ends and the opening begins. The frame wall section may have an ordinary, substantially uniform thickness wherein the frame wall's thickness is only increased in the vicinity of the opening.

Various embodiments may implement the following features:

The lifting frame may be designed for lifting a transformer or reactor, wherein the transformer or reactor may have, for example, a mass of at least 14·10³ kg.

The thickness of the frame wall section may increase with decreasing distance to the lifting opening axis in at least one step, for example in one step. Step may be understood as a short and steep transition between two frame wall sections with differing thicknesses. Such step may be a 90° step or a 75° to 105° step. This allows for a facilitated manufacturing. Alternatively, the thickness of the frame wall section may gradually increase with decreasing distance to the holding opening axis.

The thickness of the frame wall section may increase with decreasing distance to the holding opening axis in at least one step from a first thickness t1 to a second thickness t2, wherein the second thickness t2 is larger than twice the first thickness t1 and may be as large as three times the first thickness t1.

The thickness of the frame wall section surrounding the lifting opening may increase substantially symmetrically with respect to the plane.

The thickness of the frame wall section surrounding the lifting opening may show a rotational symmetry with respect to the lifting opening axis.

The frame wall section may comprise a tube member, having a longitudinal axis that is oriented substantially parallel to or that substantially coincides with the lifting opening axis. This allows for a facilitated manufacturing and a high stability of the contact area. The tube member constitutes the frame wall section with increased thickness and defines the lifting opening.

The circumference of the lifting opening may be formed by the tube member.

The tube member may extend at both sides beyond the frame wall section and thus provide an increased thickness of the frame wall section extending on both sides of the frame wall section. The increase in thickness may be equally large on both sides of the frame wall section.

The tube member may be a component part attached to a residual portion of the frame wall section. This further facilitates manufacturing.

The tube member may be attached to the residual portion of the frame wall section by a welding connection.

The tube member may be made of a metal material.

The residual portion of the frame wall section may be made of a metal material. A metal material is advantageous, since it resists harsh environmental conditions such as corrosion and extreme temperatures. Stainless steel may be beneficial, since this material shows good performance al low temperature, particularly, increased fracture toughness.

The tube member and the residual portion of the frame wall section may be made from the same material. This allows for further facilitated manufacturing.

The residual portion of the frame wall section may at least substantially show a constant thickness.

Alternatively, the frame wall section may be an integral part or one piece part.

The lifting frame may comprise a first elongate part extending along a first elongate part axis, wherein the frame wall section forms part of the first elongate part, and wherein the lifting opening is a first lifting opening. The first elongate part may further comprise a second lifting opening, wherein, as measured along the first elongate part axis, the second lifting opening is positioned by a first distance to the first lifting opening. The first distance may be for example between 300 mm and 2000 mm The first elongate part may further comprise a first fastening opening, wherein the first fastening opening is arranged such that it intersects a first plane, the first plane being normal to the first elongate part axis and the lifting opening axis laying in the first plane. Thus, the first fastening opening intersects the first plane and the lifting opening axis lies in the first plane. This facilitates an advantageous vertical alignment of the first lifting opening and the first fastening opening when the lifting frame is in operation. In this manner, an undesired horizontal force being effective on the transformer that is induced for example by an obliquely oriented lifting chain can be reduced or even practically eliminated. Thus, undesirable bending moments acting on the transformer or reactor can be avoided or at least reduced. The axis of the first fastening opening and the axis of the first lifting opening may substantially intersect.

More generally, the lifting frame allows for withstanding horizontal forces rising from non-vertically aligned lifting slings. Thus, it is particularly not necessary for an operator to adjust a lifting eye. Tie-rods connecting the lifting frame to an upper clamping profile of the transformer may be designed specifically, avoiding an oversizing. Besides, the lifting frame allows for a direct access from the outside of a transformer enclosure.

The first fastening opening may be designed to fit with a vertical tie-rod fixed or linked to an upper clamping profile of the transformer.

The lifting frame may further comprise a second elongate part, extending along a second elongate part axis parallel to the first elongate part axis. A distance between the first elongate part axis and the second elongate part axis may be for example between 400 mm and 2000 mm, for example between 500 mm and 1000 mm The second elongate part comprises a third lifting opening and a fourth lifting opening, wherein the third lifting opening is formed such that it intersects the first plane, and wherein the fourth lifting opening is formed such that it intersects a second plane, the second plane being normal to the second elongate part axis and a second lifting opening axis of the second lifting opening laying in the second plane. A distance between the first plane and the second plane may be for example between 400 mm and 2000 mm, for example between 500 mm and 1000 mm This is advantageous because it enables a particularly suitable symmetrical distribution of attacking forces.

The second elongate part may be constructed analogously to or identical to the first elongate part.

The first elongate part may further comprise a second fastening opening having a second fastening opening axis laying in the second plane.

The second elongate part may further comprise a third fastening opening having a third fastening opening axis lying in the first plane.

The second elongate part may further comprise a fourth fastening opening having a fourth fastening opening axis lying in the second plane.

The lifting frame may further comprise a first spacer part arranged between the first elongate part and the second elongate part for providing a second distance between the first elongate part and the second elongate part. The first spacer part may allow for carrying a horizontal force component developed during a lifting operation.

The first spacer part may be positioned such that it intersects the first normal plane.

The first spacer part may comprise a profile having a C-shape or a U-shape or an L-shape cross-section.

The first spacer part may comprise at least one aperture, for example two apertures. This allows for a reduction in mass. Moreover, water and/or pollutants are less likely to get stacked into the first spacer part. For example, a diameter of the at least one aperture may be between 50% and 90% of a width of the spacer part, for example between 60% and 80% of the width.

The lifting frame may further comprise a second spacer part arranged between the first elongate part and the second elongate part for providing the second distance between the first elongate part and the second elongate part, wherein the second spacer part positioned such that it intersects the second normal plane.

The second spacer part may be constructed analogously to or identical to the first spacer part.

The first elongate part and/or the second elongate part may each have an L-shape cross-section, wherein the lifting frame may further comprise at least one rib for reinforcing the profile of the first elongate part and/or the second elongate part, wherein the rib may extend between a first limb of the L-shape profile and a second limb of the L-shape profile, e.g. perpendicularly thereto. The first and the second lifting opening may be formed in the first limb. The first and the second fastening opening may be formed in the second limb. The rib may be welded to the first elongate part and/or the second elongate part. The rib allows for an enhancement of a local stiffness of the corresponding elongate part, particularly within a region, e.g., comprising the first lifting opening and the first fastening opening.

The at least one rib may be positioned, as measured along the first elongate part axis, by a third distance to the first plane, wherein the third distance is between one and three times, e.g. two times, a diameter of the first lifting opening.

The first elongate part, for example the first limb of the L-shape profile of the first elongate part may include a recess positioned, seen along the first elongate part axis, between the first holding opening and the second holding opening. For example, the recess may have a recess extension measured along the first elongate part axis that is between 20% and 50% of an extension of the first elongate part measured along the first elongate part axis. The recess may have a depth measured perpendicular to the first elongate part axis that is between 20% and 40% of the depth of the first limb of the L-shaped profile. This allows for a reduction in mass. It is advantageous to provide the recess between the first holding opening and the second holding opening, i.e. within a middle portion of the first elongate part, since stresses are generally significant lower there than the admissible ones.

In particular, the present disclosure comprises the following aspects:
1. A lifting frame for lifting a transformer or reactor, comprising:
   a frame wall section, extending within a frame wall section plane;
   a lifting opening formed within the frame wall section, wherein a lifting opening axis is oriented normal with respect to the frame wall section plane,
   wherein the frame wall section immediately surrounding the lifting opening has a thickness that increases with decreasing distance to the lifting opening axis.
2. The lifting frame of aspect 1, wherein the lifting opening is circular.
3. The lifting frame of aspect 1 or 2, wherein the lifting opening has a diameter D that is at least 80 mm, for example at least 100 mm
4. The lifting frame of aspect 1 or 2, wherein the lifting opening has a diameter D that is at least 150 mm
5. The lifting frame of any of aspects 1 to 4, wherein the thickness of the frame wall section increases with decreasing distance to the holding opening axis in at least one step from a first thickness t1 to a second thickness t2, wherein the second thickness t2 is larger than twice the first thickness t1.
6. The lifting frame of aspect 5, wherein t2≤4 t1.
7. The lifting frame of aspect 5, wherein t2≤3 t1.
8. The lifting frame of any of aspects 5 to 7, wherein the lifting opening has a diameter D, wherein 2 t2≤D≤5 t2.
9. The lifting frame of any of aspects 5 to 8, wherein the first thickness t1 is between 8 mm and 30 mm.
10. The lifting frame of any of aspects 5 to 8, wherein the first thickness t1 is between 12 mm and 15 mm.
11. The lifting frame of any of the preceding aspects, wherein the thickness of the frame wall section surrounding the lifting opening increases substantially symmetrically with respect to the plane.
12. The lifting frame of any of the preceding aspects, wherein the thickness of the frame wall section surrounding the lifting opening shows a rotational symmetry with respect to the lifting opening axis.
13. The lifting frame of any of the preceding aspects, wherein the thickness of the frame wall section is at least substantially constant outside a circular cylinder which is symmetrical with respect to the lifting opening axis, wherein the circular cylinder has a radius which equals a diameter of the lifting opening.
14. The lifting frame of aspect 13, wherein the frame wall section extends radially beyond a further circular cylinder which is symmetrical with respect to the lifting opening axis, wherein the further circular cylinder has a radius which equals twice the diameter of the lifting opening.
15. The lifting frame of any of the preceding aspects, wherein the frame wall section comprises a tube member, having a longitudinal axis that is oriented substantially parallel to or that substantially coincides with the lifting opening axis.
16. The lifting frame of aspect 15, wherein an edge of the lifting opening is formed by the tube member.
17. The lifting frame of aspect 15 or 16, wherein the tube member is a component part fixed or attached to a residual portion of the frame wall section.
18. The lifting frame of aspect 17, wherein the tube member is connected to the residual portion of the frame wall section by a welding connection.
19. The lifting frame of aspect 17 or 18, wherein the tube member is made of a metal material.
20. The lifting frame of any of aspects 17 to 19, wherein the residual portion of the frame wall section is made of a metal material.
21. The lifting frame of any of aspects 17 to 20, wherein the tube member is made of the same material as the residual portion of the frame wall section.
22. The lifting frame of any of aspects 15 to 21, wherein the tube member has a length L, as measured along the lifting opening axis, wherein 0.9 t2≤L≤1.1 t2.
23. The lifting frame of any of aspects 15 to 22, wherein the tube member has a length L, as measured along the lifting opening axis, wherein L≤3 t1.
24. The lifting frame of any of aspects 15 to 23, wherein a wall thickness of the tube member is between 0.05 and 0.5 times a diameter of the lifting opening, for example between 0.1 and 0.2 times a diameter of the lifting opening.
25. The lifting frame of any of the preceding aspects, comprising:
   a first elongate part extending along a first elongate part axis,
   wherein the frame wall section forms part of the first elongate part, and wherein the lifting opening is a first lifting opening,
   wherein the first elongate part further comprises a second lifting opening, wherein, as measured along the first elongate part axis, the second lifting opening is positioned by a first distance to the first lifting opening,
   wherein the first elongate part further comprises a first fastening opening, wherein the first fastening opening is arranged such that it intersects a first plane, the first plane being normal to the first elongate part axis and the lifting opening axis laying in the first plane.
26. The lifting frame of aspect 25, further comprising:
   a second elongate part, extending along a second elongate part axis parallel to the first elongate part axis, wherein the second elongate part comprises a third lifting opening and a fourth lifting opening,
   wherein the third lifting opening is formed such that it intersects the first plane, and
   wherein the fourth lifting opening is formed such that it intersects a second plane, the second plane being normal to the second elongate part axis and a second lifting opening axis of the second lifting opening laying in the second plane.
27. The lifting frame of aspect 26,
   wherein the first elongate part further comprises a second fastening opening having a second fastening opening axis laying in the second plane.
28. The lifting frame of aspect 27,
   wherein the second elongate part further comprises a third fastening opening having a third fastening opening axis lying in the first plane.
29. The lifting frame of aspect 28,
   wherein the second elongate part further comprises a fourth fastening opening having a fourth fastening opening axis lying in the second plane.
30. The lifting frame of any of aspects 26 to 29, further comprising a first spacer part arranged between the first elongate part and the second elongate part for providing a second distance between the first elongate part and the second elongate part.
31. The lifting frame of aspect 30,
   wherein the first spacer part is positioned such that it intersects the first normal plane.
32. The lifting frame of aspect 30 or 31, wherein the first spacer part comprises a profile having a C-shape or a U-shape cross-section.
33. The lifting frame of any of aspects 30 to 32, wherein the first spacer part comprises at least one aperture.
34. The lifting frame of any of aspects 26 to 33, further comprising a second spacer part arranged between the first elongate part and the second elongate part for providing the second distance between the first elongate part and the second elongate part, wherein the second spacer part is positioned such that it intersects the second normal plane.
35. The lifting frame of aspect 34, wherein the second spacer part is constructed analogously to or identical to the first spacer part.
36. The lifting frame of any of aspects 26 to 35, wherein the first elongate part and/or the second elongate part each having an L-shape cross-section.
37. The lifting frame of aspect 36, wherein the lifting frame further comprises at least one rib for reinforcing the profile of the first elongate part and/or the second elongate part, wherein the rib extends between a first limb of the L-shape profile and a second limb of the L-shape profile.
38. The lifting frame of aspect 37, wherein the at least one rib extends in a plane parallel to the first plane.
39. The lifting frame of aspect 37 or 38, wherein the at least one rib is positioned, as measured along the first elongate part axis, by a third distance to the first plane, wherein the third distance is between one and two times a diameter of the first lifting opening.
40. The lifting frame of any of aspects 36 to 39, wherein the lifting frame further comprises at least one further rib for reinforcing the profile of the first elongate part and/or the second elongate part, wherein the at least one further rib extends between the first limb of the L-shape profile and the second limb of the L-shape profile, wherein the at least one rib and the at least one further rib are positioned with respect to the first plane on opposite sides.
41. The lifting frame of aspect 40, wherein the at least one rib and the at least one further rib are positioned symmetrically with respect to the first plane.
42. The lifting frame of aspect 40 or 41, wherein the at least one further rib is constructed analogously to or identical to the at least one rib.
43. The lifting frame of any of aspects 26 to 42, wherein the first elongate part includes a recess positioned, seen along the first elongate part axis, between the first lifting opening and the second lifting opening.
44. The lifting frame of any of aspects 26 to 43, wherein the second elongate part is constructed analogously to or identical to the first elongate part.
45. The lifting frame of any of aspects 26 to 44, wherein at least one of, for example each of the first elongate part, the second elongate part, the first spacer part, the second spacer part, the at least one rib, and the at least one further rib comprises or consists of metal.
46. Transformer with a lifting frame according to any one of the preceding aspects.
47. Reactor with a lifting frame according to any one of the preceding aspects.

### SHORT DESCRIPTION OF THE DRAWINGS

The subject-matter of the disclosure will be explained in more detail with reference to exemplary embodiments which are illustrated in the attached drawings, in which:

FIG. 1a is a schematic normal view of a frame wall section of a lifting frame according to the present disclosure.

FIG. 1b is a cross-sectional view of the frame wall section of FIG. 1a.

FIG. 2 is a perspective view of a lifting frame according to the present disclosure.

FIG. 3 is a side view of the lifting frame.

FIG. 4 is a plan view of the lifting frame.

FIG. 5 is a front view of the lifting frame.

### DETAILED DESCRIPTION

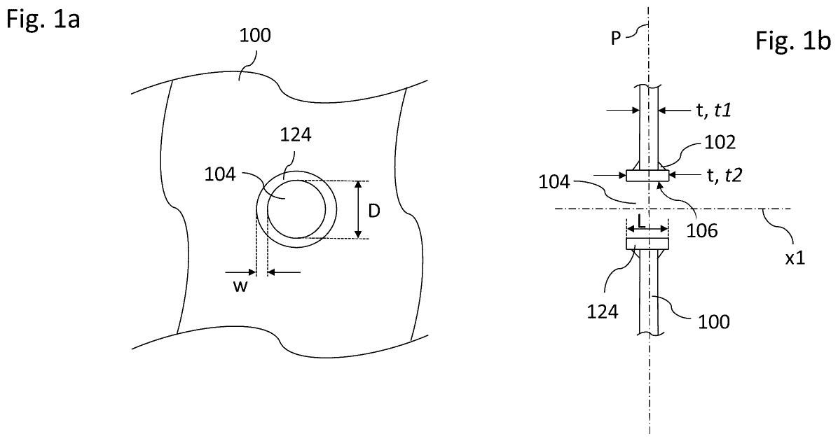

FIG. 1a is a schematic normal view of a frame wall section 100 of a lifting frame according to the present disclosure. The lifting frame is designed for lifting a transformer or reactor. The transformer or reactor may have a mass of at least 14·10³ kg. More particular, the lifting frame is designed for being linked to the transformer or reactor to be lifted and to a lifting mechanism including a hook or a similar part, e.g., a shackle. The lifting frame has at least one lifting opening 104 surrounded by a wall section 124 being thicker than the remaining frame wall section 100 thickness.

The lifting opening 104 is for example circular. The lifting opening 104 may have a diameter D that is at least 80 mm, for example at least 100 mm, or for example at least 120 mm, or for example 150 mm The diameter may be 200 mm or less.

FIG. 1b is a cross-sectional view of the frame wall section of FIG. 1a. The frame wall section 100 extends within a frame wall section plane P. A lifting opening 104 is formed within the frame wall section 100. The lifting opening 104 is designed as a point of attachment for a hook or similar part of a lifting mechanism.

A lifting opening axis x1 is oriented normal or perpendicular with respect to the frame wall section plane P. A plane of the opening lies within said frame wall section plane. The frame wall section 100 surrounds and defines the lifting opening 104.

The frame wall section 100 has a thickness t. This thickness may be generally uniform. The thickness t increases with decreasing distance to the lifting opening axis x1 in the vicinity of the lifting opening 104. This increases a contact area between a hook or other lifting mechanism and an inner surface or edge 106 of the lifting opening 104. An increased contact area is advantageous, since it leads to a reduction of the corresponding contact pressure.

As can be seen, e.g., in FIG. 1b, the thickness t of the frame wall section 100 increases with decreasing distance to the holding opening axis x1 in at least one step, for example in one step from a first thickness t1 to a second thickness t2. The second thickness t2 may be larger than twice the first thickness t1 and may be up to three times the first thickness t1 or more. The second thickness t2 may be smaller or equal to four times the first thickness t1. For example, the second thickness t2 may be smaller or equal to three times the first thickness t1.

The first thickness t1 may be between 8 mm and 30 mm, for example between 12 mm and 15 mm. The second thickness t2 may be for example between 30 mm and 70 mm

A diameter D of the lifting opening 104 may be greater than or equal to twice the second thickness t2. The diameter D may be smaller than or equal to five times the second thickness t2.

The thickness t of the frame wall section 100 surrounding the lifting opening 104 may increase at least substantially symmetrically with respect to the plane P, i.e. to both sides of the frame wall section 100. Further, the thickness t may show a rotational symmetry with respect to the lifting opening axis x1.

The thickness t of the frame wall section 100 may be at least substantially constant outside a circular cylinder which is symmetrical with respect to the lifting opening axis x1, wherein the circular cylinder has a radius which equals the diameter D of the lifting opening.

The frame wall section 100 may extend radially beyond a further circular cylinder which is symmetrical with respect to the lifting opening axis x1, wherein the further circular cylinder has a radius which equals twice the diameter of the lifting opening.

The frame wall section 100 may comprise a tube member 124, having a longitudinal axis that is oriented substantially parallel to or that substantially coincides with the lifting opening axis x1. This allows a facilitated manufacturing and a high form stability. The edge 106 of the lifting opening 104 may be formed by the tube member 124. The lifting opening 104 may be surrounded by and defined by the tube member 124. The tube member 124 may be a component attached to a residual portion of the frame wall section 100. For example, the tube member 124 may be fixed to the residual portion by a welding connection 102. The tube member 124 constitutes said area of increased thickness t2 of the frame wall section 100. The axial length L of the tube member 124 along axis x1 may be two to three times the thickness t of the frame wall section 100. The length L of the tube member 124 may essentially equal the second thickness. For example, the length L may be between 90% and 110% of the second thickness t2. The length L may be less than or equal to three times the first thickness t1.

The tube member 124 and/or the residual portion of the frame wall section 100 may be made of a metal material, such as stainless steel. This facilitates manufacturing further. The tube member 124 may be made of the same material as the residual portion of the frame wall section.

The residual portion of the frame wall section 100 may have a constant thickness that equals the first thickness t1.

The tube member 124 may have a wall thickness w between 0.05 D and 0.5 D, for example between 0.1 D and 0.2 D.

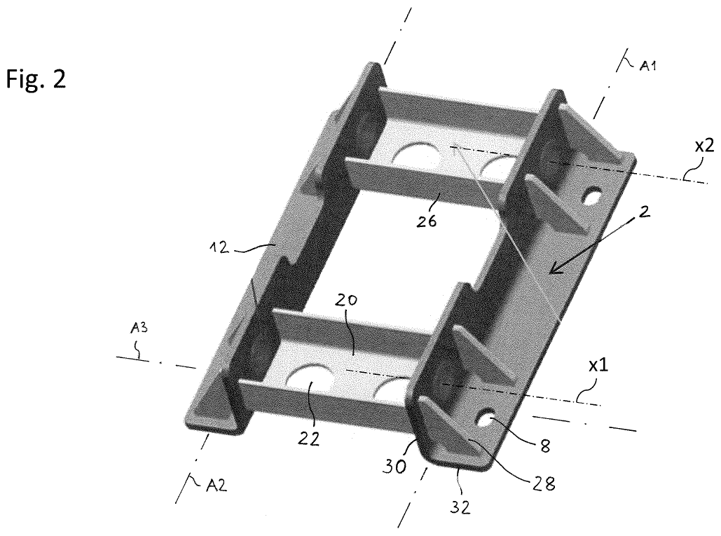

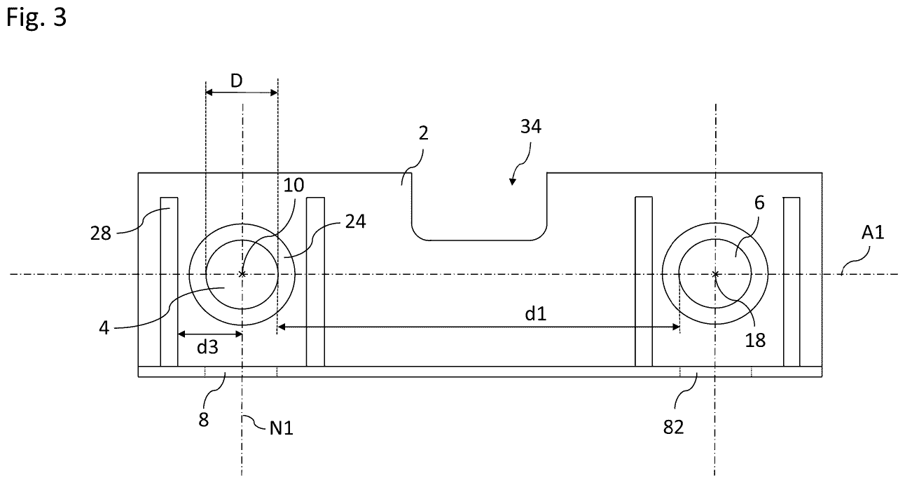

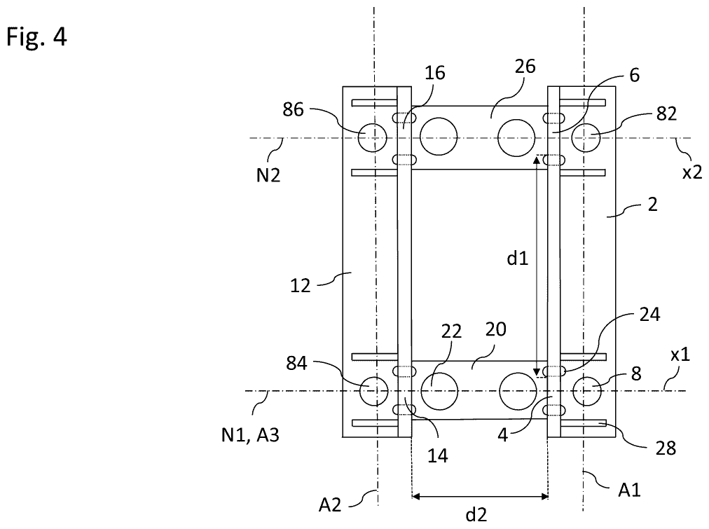

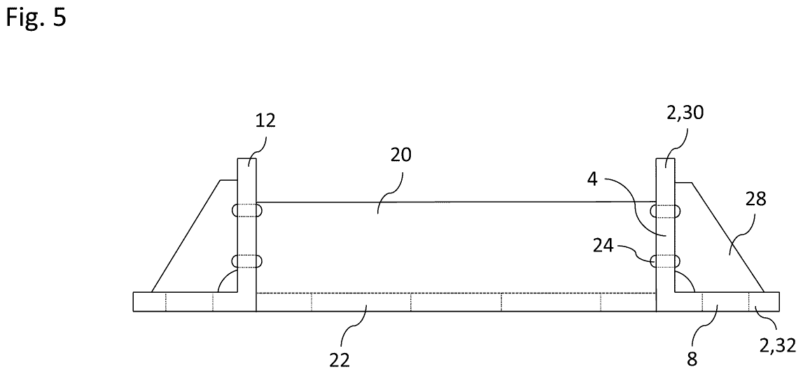

FIG. 2 is a perspective view of the lifting frame. FIG. 3 is a side view, FIG. 4 a plan view, and FIG. 5 a front view of the lifting frame.

The lifting frame comprises a first elongate part 2 extending along a first elongate part axis A1. The frame wall section 100 forms part of the first elongate part 2, and the lifting opening 104 is a first lifting opening 4.

The first elongate part 2 further comprises a second lifting opening 6, wherein, as measured along the first elongate part axis A1, the second lifting opening 6 is positioned by a first distance dl to the first lifting opening 4. The second lifting opening 6 may be constructed analog to the first lifting opening 4.

The first elongate part 2 further comprises a first fastening opening 8. The first fastening opening 8 is designed as a point of attachment for a bearing part of the transformer or the reactor or for a bearing part carrying the transformer or reactor, e.g., in the form of a tie-rod.

The first fastening opening 8 is arranged such that it intersects a first plane N1, the first plane N1 being normal to the first elongate part axis A1, wherein the lifting opening axis x1 lays in the first plane N1.

Further, the lifting frame comprises a second elongate part 12, extending along a second elongate part axis A2 parallel to the first elongate part axis A1. The second elongate part 12 may be constructed identical to the first elongate part 2. The second elongate part 12 comprises a third lifting opening 14 and a fourth lifting opening 16. All lifting openings of the lifting frame may be designed analogously or substantially identical. All lifting openings may be arranged substantially symmetrically.

The third lifting opening 14 is formed such that it intersects the first plane N1. The fourth lifting opening 16 is formed such that it intersects a second plane N2 that is normal to the second elongate part axis A2, wherein a second lifting opening axis x2 of the second lifting opening 6 lies within the second plane N2.

The first elongate part 2 may further comprise a second fastening opening 82, with a second fastening opening axis laying in the second plane N2.

The second elongate part 12 may further comprises a third fastening opening 84 and a fourth fastening opening 86, with a third fasting opening axis laying within the first plane N1 and a fourth fastening opening axis laying in the second plane N2. The first elongate part 2 and the second elongate part 12 may be constructed analogously or identical.

The lifting frame may further comprise a first spacer part 20 arranged between the first elongate part 2 and the second elongate part 12 for providing a second distance d2 between the first elongate part 2 and the second elongate part 12. The first spacer part 20 may be positioned such that it intersects the first normal plane.

The first spacer part 20 may comprise a profile having a C-shape or a U-shape or an L-shaped cross-section. The first spacer part 20 may comprise at least one aperture 22, for example — as sketched — two apertures 22. The first spacer part may be a profile having an axis oriented parallel to or laying within the first plane N1.

The lifting frame may further comprise a second spacer part 26, arranged between the first elongate part 2 and the second elongate part 12 for providing the second distance d2 between the first elongate part 2 and the second elongate part 12, wherein the second spacer part 26 is positioned such that it intersects the second normal plane N2.

The second spacer part 26 may be constructed analogously to or identical to the first spacer part 20.

Further, the first elongate part 2 and/or the second elongate part 12 may be profiles, each having an L-shape cross-section, as sketched exemplarily in FIG. 5. Accordingly, the profile shows a first limb 30 and a second limb 32.

The lifting openings may be provided in the first limb 30, and the fastening openings may be provided in the second limb 32.

The lifting frame may further comprise at least one rib 28 for reinforcing the profile of the first elongate part 2 and/or the second elongate part 12. The rib 28 extends between the first limb 30 of the second limb 32. The at least one rib 28 may extend in a plane parallel to the first plane.

The at least one rib 28 may be positioned, as measured along the first elongate part axis A1, by a third distance d3 to the first plane N1, wherein the third distance d3 is one to twice the diameter D of the first lifting opening 104. Further corresponding ribs may be provided analogously vis-á-vis each of the other lifting and fastening openings.

The lifting frame may further comprise at least one further rib for reinforcing the profile of the first elongate part 2 and/or the second elongate part 12, wherein the at least one further rib extends between the first limb 30 of the L-shape profile and the second limb 32 of the L-shape profile, wherein the at least one rib 28 and the at least one further rib are positioned with respect to the first plane N1 on opposite sides. The at least one rib 28 and the at least one further rib may be positioned symmetrically with respect to the first plane N1. The at least one further rib may be constructed analogously to or identical to the at least one rib 28.

The first elongate part 2 may further include a recess 34 positioned, seen along the first elongate part axis A1, between the first lifting opening 4 and the second lifting opening 6.

At least one of, for example each of the first elongate part 2, the second elongate part 12, the first spacer part 20, the second spacer part 26, the at least one rib 28, and the at least one further rib may comprise or consist of metal.

While the present disclosure has been described in detail in the drawings and forgoing description, such description is to be considered illustrative or exemplary and not restrictive. Variations to the disclosed embodiments can be understood and effected by those skilled in the art and practicing the claimed subject-matter, from a study of the drawings, the disclosure, and the appended claims. In the claims, the word “comprising” does not exclude other elements, and the indefinite article “a” or “an” does not exclude a plurality. The mere fact that certain elements or steps are recited in distinct claims does not indicate that a combination of these elements or steps cannot be used to advantage, specifically, in addition to the actual claim dependency, any further meaningful claim combination shall be considered disclosed.

1. A lifting frame for lifting a transformer or reactor, comprising:
a frame wall section, extending within a frame wall section plane; and
a lifting opening formed within the frame wall section, wherein a lifting opening axis is oriented normal with respect to the frame wall section plane,
the frame wall section immediately surrounding the lifting opening having a thickness that increases with decreasing distance to the lifting opening axis, such that the thickness of the frame wall section surrounding the lifting opening increases substantially symmetrically with respect to the plane.

2. The lifting frame of claim 1, wherein the thickness of the frame wall section increases with decreasing distance to the lifting opening axis in at least one step from a first thickness t1 to a second thickness, wherein the second thickness is larger than the first thickness.

3. The lifting frame of claim 1, wherein the thickness of the frame wall section surrounding the lifting opening shows a rotational symmetry with respect to the lifting opening axis.

4. The lifting frame of claim 1, wherein the frame wall section comprises a tube member, having a longitudinal axis that is oriented substantially parallel to or that substantially coincides with the lifting opening axis.

5. The lifting frame of claim 4, the frame wall section with increased thickness of the lifting opening is formed by the tube member.

6. The lifting frame of claim 4, wherein the tube member attached to a residual portion of the frame wall section.

7. The lifting frame of any of claim 4, wherein the tube member is made of a metal material.

8. The lifting frame of claim 1, comprising:
a first elongate part extending along a first elongate part axis,
wherein the frame wall section forms part of the first elongate part, and wherein the lifting opening is a first lifting opening,
wherein the first elongate part further comprises a second lifting opening, wherein, as measured along the first elongate part axis, the second lifting opening is positioned by a first distance to the first lifting opening,
wherein the first elongate part further comprises a first fastening opening, wherein the first fastening opening is arranged such that it intersects a first plane, the first plane being normal to the first elongate part axis and the lifting opening axis laying in the first plane; and
a second elongate part, extending along a second elongate part axis parallel to the first elongate part axis, wherein the second elongate part comprises a third lifting opening and a fourth lifting opening,
wherein the third lifting opening is formed such that it intersects the first plane, and
wherein the fourth lifting opening is formed such that it intersects a second plane, the second plane being normal to the second elongate part axis and a second lifting opening axis of the second lifting opening laying in the second plane.

9. The lifting frame of claim 8, further comprising a first spacer part arranged between the first elongate part and the second elongate part for providing a second distance between the first elongate part and the second elongate part.

10. The lifting frame of claim 9, wherein the first spacer part comprises a profile having a C-shape or a U-shape or an L-shape cross-section.

11. The lifting frame of claim 9, wherein the first spacer part comprises at least one aperture.

12. The lifting frame of claim 8, wherein the first elongate part and/or the second elongate part each having an L-shape cross-section, wherein the lifting frame further comprises at least one rib for reinforcing the profile of the first elongate part and/or the second elongate part, wherein the rib extends between a first limb of the L-shape profile and a second limb of the L-shape profile.

13. The lifting frame of claim 12, wherein the at least one rib is positioned, as measured along the first elongate part axis, by a third distance to the first plane, wherein the third distance is up to twice a diameter of the first lifting opening.

14. The lifting frame of claim 8, wherein the first elongate part includes a recess positioned, seen along the first elongate part axis, between the first lifting opening and the second lifting opening. (New) A transformer, comprising:
an enclosure; and
a lifting frame coupled to the enclosure, the lifting frame comprising:
a frame wall section, extending within a frame wall section plane; and
a lifting opening formed within the frame wall section, wherein a lifting opening axis is oriented normal with respect to the frame wall section plane,
the frame wall section immediately surrounding the lifting opening having a thickness that increases with decreasing distance to the lifting opening axis, such that the thickness of the frame wall section surrounding the lifting opening increases substantially symmetrically with respect to the plane.

16. The transformer of claim 15, wherein the thickness of the frame wall section increases with decreasing distance to the lifting opening axis in at least one step from a first thickness t1 to a second thickness, wherein the second thickness is larger than the first thickness.

17. The transformer of claim 15, wherein the thickness of the frame wall section surrounding the lifting opening shows a rotational symmetry with respect to the lifting opening axis.

18. A method, comprising:
coupling a lifting frame to an enclosure of at least one of a transformer and a reactor, the lifting frame comprising:
a frame wall section, extending within a frame wall section plane; and
a lifting opening formed within the frame wall section, wherein a lifting opening axis is oriented normal with respect to the frame wall section plane,
the frame wall section immediately surrounding the lifting opening having a thickness that increases with decreasing distance to the lifting opening axis, such that the thickness of the frame wall section surrounding the lifting opening increases substantially symmetrically with respect to the plane; and
lifting the lifting frame to lift the enclosure.

19. The method of claim 18, wherein the thickness of the frame wall section increases with decreasing distance to the lifting opening axis in at least one step from a first thickness t1 to a second thickness, wherein the second thickness is larger than the first thickness.

20. The method of claim 18, wherein the thickness of the frame wall section surrounding the lifting opening shows a rotational symmetry with respect to the lifting opening axis.
